(19) United States
(12) Patent Application Publication
(10) Pub. No.: US 2010/0001933 A1
(43) Pub. Date: Jan. 7, 2010

(54) Display Device

(75) Inventors: Tim Coker, Kent (GB); Simon Smith, Sussex (GB); Paul Silsby, Sussex (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: AARDVARK ENGINEERING CONSULTANCY LTD., East Sussex (GB)

(21) Appl. No.: 12/439,188

(22) PCT Filed: Aug. 10, 2007
(86) PCT No.: PCT/GB2007/003060

§ 371 Date: Feb. 27, 2009

(30) Foreign Application Priority Data
Aug. 29, 2006 (GB) 0616993.2

(51) Int. Cl. G09G 3/32

(52) U.S. Cl. 345/83; 345/82

(57) ABSTRACT

A display including a plurality of discrete pixel means supported on cables and arranged to form a display of a size not possible with prior art. Advantageously the cables are also used to distribute power and data to the pixels. The pixel means may also include a processor and sensing means that enable the pixel means to operate with significant autonomy.

This invention relates to the provision of display panels, usually in the form of very large, and therefore outdoor, display screens. By very large it is meant on the whole screens sizes in excess of 80 or 100 m², possibly as large or larger than 1000 m². Such display panels find application, for example, in outdoor areas and on buildings. They may display advertising or any other suitable material or content.

Large screens suitable for outdoor use are already known, of course, the predominant technology being based on LEDs. Examples of these screens are made by manufacturers such as Barco, Lighthouse and Unitek and can most often be seen at sports stadia and large outdoor concerts. In practice the size of these screens is limited to a few tens of square metres, 30 m² or so being quite common, 60 m² being amongst the largest permanently installed. There are rare examples of very large LED screens, for example a 300 m² screen is described in the May 2005 edition of AV Magazine, however this was a one-off installation for a particular show, such a screen being much too expensive to install on a permanent basis. Large LCD based outdoor screens are also known, see for example WO 03/016989; again 60 m² being the largest known.

There are a small number of lighting effect systems in operation worldwide that would be considered to be in the very large category and could be loosely termed displays. For example the exterior of the Galleria West shopping mall in Seoul:—a 4500 m² facade with custom designed glass discs backlit with LEDs (UN Studio Architects/Arup Lighting, Amsterdam), and KPN Headquarters, Rotterdam:—a 3000 m² monochrome display made up of OSRAM Planon flat fluorescent lamps mounted on the exterior of a tall office block. Of these the Rotterdam example is the most display-like, as the Planon lamps act approximately as pixels.

Whilst prior art outdoor screens are becoming commonplace nowadays, there are various issues which limit both their performance and, more importantly for this application, their size. Both the LCD and LED screen types currently used are emissive in nature, that is they create images by emitting light which is modulated according to the image data. This fact leads to 2 principal observations: the screens consume large amounts of power (in the case of the LCD variant, very large amounts of power) and the physical components necessary to create, emit and modulate this light are bulky and heavy. In these cases, structural issues limit the size of a screen which can be constructed and this is why we do not observe prior art screens of great sizes—the 300 m² screen mentioned above weighed 45 tonnes, and had to be constructed in 2 halves as this weight was too great for the normal supporting structure.

Another display-like product is the MiPix product from Barco. MiPix is an emissive LED product and therefore has all the same disadvantages of size/weight, power consumption and so forth. Unlike the presently disclosed invention it is not an actual display in that it is not used to display images (in the same way that the KPN building does not display images), but merely for lighting effects—Kylie Minogue concerts being one example. The size of arrays of MiPix are further limited by the manner in which power, particularly, and data are passed to the individual units; whilst fairly large arrays are possible, very large arrays are not observed.

When it comes to performance, all emissive displays are limited by the contrast they can display in bright ambient conditions. As these screens are most often sited outdoors, ambient illumination cannot be controlled in the same way as for an indoor site and in practice the observable contrast of such screens is limited to around 20:1. In cases of direct sunlight, such an emissive screen can washout completely.

Of course the other practical reason why very large screens are not available is cost. Data from LED manufacturers indicate that such screens cost around £5000 per square metre—this is a median value, there are cheaper products, similarly there are ones which are much more expensive (−£20 k per square metre for higher resolution products for example)—furthermore these costs only include the actual screen modules and not the supporting structure, nor any necessary control equipment. On this basis even a 1000 m² screen becomes prohibitively expensive as well as difficult to construct and support, structurally, on this sort of scale.

Thus, if one wishes to build a very large screen, there is a requirement for a technology that overcomes or at least mitigates some or all of the problems of cost, size/weight, power consumption and performance under bright ambient illumination.

The invention is defined in the independent claims, to which reference should now be made. Advantageous embodiments are set out in the sub claims.

One important feature of invention embodiments is that they modify optical properties, typically reflectance or transmittance, rather than using an emissive approach to creating an image, in other words displays constructed according to the invention are passive and not active (i.e. emissive). Straightaway this overcomes the problems of power and therefore also size and weight, and, in the case of reflective light modulators particularly, embodiments will also retain their contrast under all ambient illumination conditions. As a considerable proportion of the cost of an emissive system is bound up in managing and providing electrical power, a passive technology is generally cheaper than an active technology.

Of course, reflective and transmissive light modulators are well known, the earliest and perhaps most common example of the former being the digital watch, but other examples include many electronic calculators and other low resolution text based displays in a plethora of modern appliances, microwave ovens for example. However all of these examples are small by their nature and it is not obvious how this technology can be scaled up by several orders of magnitude in order to produce a very large display.

One of the aspects common to all of the prior art displays so far described is that they are, to a greater or lesser degree, integrated. That is, the essential module that such displays comprise, integrates a number of pixels as a single structural entity, for example a flat screen LCD TV integrates something of the order of 1 million pixels onto a single glass substrate; even a very simple LCD text display integrates 16 or so characters each comprising perhaps 30 to 40 pixels; the LED screen modules integrate something like 1000 pixels and so on. Each of these displays or modules has a single structural entity providing all of the pixels.

For all these examples, indeed for all screens and displays currently available, integration is the means by which large displays both can be made and can be afforded. To illustrate the latter point, if the cost per pixel of an LCD TV was even 1 penny, then such a TV, with a medium resolution of 1024×768 pixels, would cost nearly £8000. This is clearly too much for the market, and in practice LCD TVs are available for much less than £1000. Note that, within this application, the term integration (unless the context clearly demands otherwise) refers to the combination of a plurality of pixels into a single structural element, for example a plurality of pixels are integrated onto a single glass substrate, and so on. LCD TVs exhibit a very high degree of integration, that is 100,000 to 1,000,000 or more pixels are integrated as a single structural entity. The LED screen modules exhibit a medium level of integration, LCD text displays might be considered to exhibit a low degree of integration, whereas the invention embodiments disclosed here utilise a very low degree of integration at most, and in the currently preferred embodiment, no pixel integration at all—each pixel is an individual, discrete item or cell and there are a plurality of such structurally independent cells forming a display.

Although integration is the key to small, medium and even large screens, if one wants to make a very large screen, the present inventors have come to the surprising realisation that integration actually becomes the enemy and not the friend of the engineer—single integrated structures in excess of 100 m² are difficult and expensive to build.

To elaborate this point further, the inventors have realised that integration brings with it an “overhead”, this overhead is often structural and/or mechanical in nature; for example the overhead for a LCD TV is the large glass substrate, especially as optically flat glass is difficult and expensive to make. Where the end product is modestly sized, this overhead is acceptable, especially as the high level of integration drastically reduces other costs. For example current mother glass used in the manufacture of LCD TVs can be as large as several square metres, but it requires not only highly specialised manufacturing techniques, but also innovative and novel techniques merely to ship and handle it; this is another aspect of the overhead referred to, an operational overhead perhaps. To use a numerical example, a 1000 m² screen built using such mother glass and prior art techniques, would require perhaps 250 sheets of this glass.

Even if one is able to handle these and build them into a screen, this sort of glass is much too fragile to withstand the rigours of an outdoor environment on such a scale, and considerable additional structure would be required just to support them and prevent catastrophic damage. The essential point is that, whilst the size of the end product remains modest, the integration overhead remains acceptable, but as the size increases the overhead becomes predominant, to the point where it is no longer acceptable.

In order to build very large outdoor screens one must overcome or at least mitigate the disadvantages of the prior art, and the invention embodiments do this with a plurality of structural elements referred to as “cells” which utilise a light modulating or passive rather than an active or emissive technology and which further utilise as low a degree of integration as possible.

A further advantage of using very low, or even zero (one pixel per cell), degrees of integration is that the resultant display system becomes almost limitlessly scalable. This is because the integration overhead has effectively been eliminated, and therefore one can continue to increase the size of a screen limited only by the size of the site or structure one is utilising. In this way very large screens well in excess of 100 m² in size can be easily and rapidly built, but this is only true provided the other issues of size/weight and power etc have also been eliminated, and therefore very large screens need to be both non-integrated and utilise a light modulating or passive technique to be truly scalable. The method of modulation can be any suitable method known to the art, for example, the Grating Light Valve or other MEMS types methods but the currently preferred method is a liquid crystal one.

Although such a scalable display screen embodiment can be used for smaller screen sizes, in these cases the low integration militates against such displays, for reasons of costs particularly and according to the traditional cost model for prior art screens. Thus the preferred size for the current invention is what has been termed ‘very large’, this is considered to be 80 m² or 100 m² or larger. In theory the screen size is unlimited, as the underlying technology is scalable, but certain practical issues may limit the size to around 10,000 m², that is at least 100 times larger than prior art displays.

Whilst the currently preferred embodiment is for zero integration (that is a single, discrete pixel each in a cell) other, non-zero, degrees are possible. For example it might be more economic, in some circumstances, to integrate perhaps 4 pixels in a 2×2 cell array. It is unlikely that a cell in the context of the present application will integrate more than 4 pixels together. The current embodiment preferably places the pixels on a 10 cm pitch, with the pixels themselves being at least 5 cm², for example, approximately 8 cm² in size.

Mechanical and electrical connections to the cells can use any conventional technology. Preferably, one or more cables (which may be flexible or inflexible, solid, multi-stranded or of any other suitable form) are connected to each cell. Some or all of these cables may also act as a support for the cell. Note that the term cable should not necessarily be interpreted in the narrow sense of something that is akin to rope or string, albeit electrically conductive. For example such a cable might be a track on a PCB or flexible heat seal connector and so on.

Thus, in a currently preferred embodiment, data and power are distributed to each pixel means along cables, these cables serving the dual purpose of carrying the structural weight of the cell (and in this case the cables are in fact ‘rope-like’). Note that where power is supplied to a pixel or cell, an earth return path is also provided. Clearly the use of cables in such a way can be an advantageous method of stabilising and supporting a structure, in that the additional weight of the purely structural components is as low as possible (cf the use of cabling in suspension bridges). This use of cables is therefore another way of reducing the structural and mechanical overhead referred to above. A further advantage of using cables in this way is that the resultant structure is flexible, and therefore screens built in such a way can be fitted to structures that are not flat.

Preferably a maximum of four cables connect to a cell, advantageously one power cable, one data cable, one address cable and one earth return cable with at least one of these cables being disposed so as to support the weight of the cell.

Advantageous though the use of cabling is, it is still preferable to use as little cabling as possible. The basic requirements of a cell are: power, earth return and data, plus a means to indicate to each cell that it is being addressed, i.e. the select or address function. Therefore, in the simplest embodiments 4 cables are used: power, earth return, data and an address cable; however it is possible to combine at least 2 of these functions onto a single cable. For example power and data can be multiplexed onto a single cable, provided the cell has additional means to store energy locally whilst the voltage on the cable supplying power is modulated by the data being transmitted; such additional means is typically a capacitor.

There are various ways in which cables can be used to construct an array of cells, for example each cell (except the top cell in a column of course) could be attached to the cell above by an individual cable. Here, each cell is attached to at least 2 cables, one going to the cell above, one below. There are disadvantages to this method, in that twice as many cell to cable connections are required as for other techniques, but, more crucially, the connections at the top of a column need to be strong enough to support not only the weight of all the cells below, but also all the cables attached to the cells below.

The inventors have found that a better technique is to use a single continuous cable and attach each cell to this cable, thus each connection need only be strong enough to support the minor weight of a single cell, not the weight of a whole column of cells.

Advantageously at least one cable is substantially horizontal in use. Usually at least one cable is substantially vertical in use when the display as a whole is mounted substantially vertically.

Typically at least one cable would be strung horizontally rather than vertically, by doing so a degree of horizontal structural integrity is provided, without this it would be much more difficult to control the horizontal spacing of the pixels (the vertical spacing being controlled by any vertically strung cables). The use of a horizontal cable has the further advantage that it allows a form of row/column addressing to be used when the horizontal cable carries the cell select signal. According to a further development of the invention, at least one of the said cables is strung substantially horizontally, the rest substantially vertically.

Note that in the description so far, it has been assumed that the display as a whole is supported in a substantially vertical plane, as would be normal for a display. However other angles are possible. For example it can be common to tilt a display slightly downwards to aid observation and control the way ambient illumination is reflected. In the extreme of course, a display could be laid out in a substantially horizontal plane, for example to display under floor images where the actual floor surface is transparent. In these cases, where cables are employed as described above, some or all of the cables may be substantially horizontal, but it is advantageous that at least one cable is laid out substantially orthogonally to the other cables. Put another way, the cables can be grouped into 2 sets, within any such set the cables are substantially parallel (this in fact defining the set) but each set is substantially at right angles to the other.

Given that each pixel in a display must, in general, be able to display different data from its neighbours, where a cell comprises more than one pixel, there must be a further means to determine which data is meant for which pixel. This can be done by a simple formatting of the data transmitted to each cell.

According to a further development of the invention the horizontal cable is used to supply the cell select signal so as to enable a row/column addressing scheme.

Given that a cable based system is considered an advantageous method for both addressing and structurally supporting the cells that form a display screen according to many of the invention embodiments, the means by which cells connect to and are attached to these cables becomes important. Various options are available, from a simple mechanical pressure joint, to soldering. A method that is particularly advantageous, if steel wire rope is being used as the cabling, is to use a sharp pin of an appropriate size and shape. This can then be pushed into the strands of the cable to make a connection both strong enough to support the weight of the cell and secure enough to provide a good electrical connection. If the pin is part of the cell shell, but the latter has at least two parts that are clamped together, then the process of clamping the two parts together can be used to embed the pin into the cable.

In one preferred embodiment a cable is formed of strands and the means for attaching the cell to the said stranded cable in use includes a pin that is embedded into the cable forming a mechanical and optionally an electrical connection. In another preferred embodiment a cell is attached to a cable via a soldered connection in use. If the cell is to be soldered to the cabling, then this is greatly facilitated by the use of an appropriate flux material.

According to a yet further development of the invention, each cell is provided with a local means of storing energy (for example a capacitor), such that power and data can be multiplexed onto a single cable.

Preferably a processor and/or memory is provided for each pixel cell.

In a currently preferred embodiment, a zero degree of integration is utilised, that is each pixel is a single discrete component ie a cell. Each discrete pixel may comprise the following principal components: a liquid crystal modulator configured for a reflective or transmissive mode of operation, a microprocessor for receiving data from a control system and generating the drive waveforms for the light modulator, a PCB on which to mount the microprocessor and other ancillary electrical components, the purpose of which will be obvious to those skilled in the art, and a shell to carry these and enclose them in a manner that protects them from the environment.

The presence of a microprocessor, and the memory associated with such a processing device, at each pixel or cell is a considerable computational advance on any prior art display screen or system. Smart pixel structures are already known but they generally serve purposes other than as picture elements, for example to provide optical neurons in neural net applications. In the case of present invention embodiments, however, each pixel includes not only computational power but also memory, this memory can be volatile or non volatile. The purpose of volatile memory (over and above that normally required for a microprocessor) will be fairly obvious to those skilled in the art, in that all display screens require some sort of memory device for storing the image data that is to be displayed. The earliest screen, that is the cathode ray tube, stored the data by means of the phosphor decay; in comparison active matrix screens such as those based on TFTs store the data in the form of a voltage across the pixel capacitor and so on.

Where the microprocessor has non-volatile data memory this has the facility to store image and other types of data even without power being applied to the pixel. If there is only volatile memory, other types of data can be transmitted to the pixels using the same process as for image data, during a setup period for example, when a screen is first powered on.

In the case of present invention embodiments, the provision of formal electronic memory enables more than a single frame of data to be stored at any one time, and the presence of the computational power enables choices to be made from amongst this memory (both volatile and non-volatile). For example a set sequence of images (or pixel data) could be stored in the non-volatile data memory and these could be displayed without any external command, allowing for a screen with no external controller, only needing power to be supplied. If look-up table data is stored in non-volatile data memory (or transmitted to volatile memory during set-up), this can be used to implement a variable “gamma” function, and so on. Again all these advantageous features arise from the presence of a microprocessor or equivalent means together with memory at each pixel or cell.

For example, there may be provided a scalable display screen system in which each cell further includes at least one processor means which itself further includes memory; said memory storing multiple sets of image and other data and said processor providing the means by which choices from amongst this data can be made in order to modify advantageously the manner in which each light modulating element is controlled.

Where a microprocessor is included, usually, and certainly for the case of the pixel means with just one pixel, there would be provided a microprocessor means for each individual pixel, in this way the pixel ratio to microprocessor is 1:1. However it is possible to control more than one pixel with a single microprocessor means, for example there may be only a single processor for a 2×2 array of pixels; in this case the pixel to microprocessor ratio is 4:1.

Preferably, the processor has the capability to overwrite said non-volatile memory with data passed to the cell dynamically.

In the case where non-volatile data memory is provided, then additional means to modify this non-volatile data can also be provided. The new data is transmitted to the pixel dynamically, that is, in the same manner as image data, but a code of some sort would be embedded into the data (more usually it would immediately precede the data) to switch the processor means into a mode that allows the non-volatile data to be over written. As an extension of this capability, the non-volatile program (as distinct to data) memory can also be re-written, a process commonly referred to as ‘bootloading’.

If sensors of various sorts are also provided at each pixel or cell, then the computational power can be used in yet further advantageous ways, for example purposes such as temperature compensation; other examples of such sensors would include ambient light sensing means. In the case of a temperature sensor, it can be the case with liquid crystal modulators that the optical response (usually for a reflective mode, the contrast ratio) to a given electrical drive waveform can vary with temperature.

In this case there will be an optimal temperature for a particular waveform, or conversely an optimal waveform for a particular temperature. The combination at each pixel of a temperature sensor, the means to store in memory the data from which different waveforms can be derived, and the computational power to choose the correct waveform according to the output of the temperature sensing means provide for a system of temperature compensation. Similarly to the case for the processing means, for each cell there may be provided one or more sensing means.

If the microprocessor also incorporates non-volatile memory of the EEPROM type, and the microprocessor further has the means to write to this memory, then it is often the case that the duration of such a write operation is temperature dependent. In this case a novel method of temperature sensing becomes available—the microprocessor may have to, in effect, idle whilst the EEPROM write operation takes place, if it counts instruction cycles during this period then the total number of cycles counted in this way will be indicative of the current operating temperature of the microprocessor. The use of a simple look-up table technique can then be used to derive an actual temperature value from this instruction cycle count.

Although the use of a horizontal or row cable has advantages, as described above, it is not the only way to achieve the pixel select function. If each cell is unique in some way, such as by embedding a unique number into the non-volatile memory of a microprocessor, the pixel select function can be integrated into the datastream, thus saving a further cable. In practice not all pixels within a screen need to be uniquely identified, but only those connected to a single data cable.

In one embodiment cells are arranged in an array of columns and rows, where each column of cells is connected to a single cable that distributes data. In this way each cell in that column needs a number unique to the column only, that is a row number. In this way individual pixels can be addressed by prefixing the data with this unique row number or address.

A variation of this scheme, which has the advantage that the pixels do not need to know their identity, is to address each pixel by its physical location within a column of pixels. In another embodiment cells are arranged in an array of columns and rows, where each column of cells is connected such that data is passed into a cell and modified data is passed out of a cell and into the next cell, said modification amounting to a means whereby each cell can deduce the data that is intended for that means, from the complete data set received, without any further means of addressing other than the relative location of the cell within the said column.

Provided the total set of data to be sent to each cell has a standard format known to the cell in advance (typically a standard length of data for each cell will suffice, with the data for that cell having a known place within the complete data packet), then the entire data for a column can be formed into a single packet. This is then transmitted to the first cell on the column, this cell then strips off its own data and passes the rest of the data packet onto the next cell. The next cell then repeats this process and sends the packet to the subsequent cell. This process repeats until the last cell in the chain receives a packet of data that consists of only the data for that cell. The disadvantage of this method is that it requires each cell to have separate in and out connections to the column cabling, whereas previous methods only require an in connection (the data is in effect broadcast to all the pixels simultaneously), there are other disadvantages too, these are described above and relate to the requirement for such connections to be able to support the weight of all the cells attached below any individual cell.

Embodiments of the invention, so far described, have generally been based on a cell consisting of a single pixel. However a particularly advantageous development is to have a cell of 3 pixels; in this case each pixel within this group of 3 is constructed so as to reflect or transmit light in only one of the 3 primary colours (that is red, green or blue). Where this arrangement is used, it is conventional for each individual coloured element to be referred to as a sub-pixel, and the three together as a pixel. This selective reflectance or transmittance can be achieved in various ways, one such being the use of tinted windows over each individual sub-pixel. In the case of a reflective cell, this can also be achieved by tailoring the reflector behind each sub-pixel to reflect only the required colour. A particularly advantageous improvement is to include a photo-luminescent material that will emit light of the required colour rather than just reflect or transmit light of the right colour and absorb the rest. The use of coloured pixel elements in this way allows for a full colour display to be constructed. In some cases a subtractive colour scheme may be used, in which case the 3 colours required will be cyan, magenta and yellow.

According to a development of the invention, therefore, there is provided a display device as previously described and wherein each cell comprises three sub-pixels (or pixels) and each individual sub-pixel reflects or transmits light in only one of the three primary or secondary colours.

Preferably, each coloured pixel further includes a photo-luminescent material that will emit light of the required colour.

Another means to achieve a full colour display, but one that does not involve coloured sub-pixels, is possible if one can control the ambient light with which the display is viewed; in practice this is most achievable at night. In this case the display is illuminated by external lighting, the colour of which can be varied rapidly and in a controlled manner—a typical example of this would be a white light source and a rotating colour wheel. The image data passed to the pixels is then synchronized with the colour of the illumination, such that separate images in each of the primary colours will be observed; provided this is done quickly enough the observer will actually see a full coloured image.

The means by which the data is synchronised to the colour of the illumination can be the use of a notch, or equivalent, in the colour wheel. This will serve to amplitude modulate the illumination in a certain way, this in turn can be observed by a suitable sensor incorporated into the display at an appropriate place, from which a synchronisation signal can be derived to control the distribution of the appropriate data to the pixels. An alternative is to incorporate a colour sensor into the screen that will sense the colour of the illumination and from which the required synchronisation signal can also be derived.

Using an extension of the latter technique, and the use of sensing and processing means as previously described, the need for synchronisation between the display system (as opposed to the individual cells) and illumination can be eliminated. In this case each pixel means incorporates a colour sensor; data for all 3 colours is transmitted to each pixel non-synchronously, and the pixel then autonomously displays the correct image data according to the colour of the illumination that it senses.

In order to minimise the complexity of the colour sensor, the facilities of the microprocessor means can be further utilised provided such means includes an ADC, which is in fact highly typical. If the light sensor has a known or predictable wavelength dependence (which is typically the case for silicon photo-diodes, for example) then the analogue output of such a sensor will in fact be colour dependent provided the intensity of the illumination is also known (which is the case where one is controlling the ambient illumination as described above). This analogue output can then be sampled by the ADC, the resultant value being used to derive the colour of the illumination and therefore can be used to synchronise the image data to the illumination. All this is achieved at the pixel level and no explicit synchronisation between display and illumination (such as the notched colour wheel described above) is required.

In situations where there is both sufficient ambient illumination for the screen to be viewed but also a means of illuminating only a portion of the screen with variable colour (for example a white spotlight with a colour wheel), then the above techniques can be used to create the highly novel effect of a screen that displays colour only in certain places.

According to a further development of the invention, therefore, there is provided illumination means and a means to synchronise the colour of light used to illuminate the screen to the data transmitted to each pixel such that a full colour image is observed.

According to a yet further development of the invention, the sensing means is able to sense the colour of light used to illuminate the screen such that each cell is able to autonomously display the correct image data according to the sensed illumination colour such that a full colour image is observed.

A perennial problem of display screens, particularly outdoor screens, is the amount and manner in which ambient light is reflected from the first display surface. As this light is not modulated, the effect can be to distract from the image formed by the light that is modulated. In the case of emissive displays, this has the principal effect of drastically reducing the contrast from a ‘darkroom’ figure that can be as high as 1000:1 to a practical figure, in normal outdoor viewing conditions that can be 20:1 or lower—much lower in some case where the ambient illumination is particularly bright, causing the screen to almost completely washout. In the case of LCD screens there can be the additional effect of specular reflections rather than diffuse. In this case images of bright objects can be observed in the screen when viewed as a whole, this is due to the fact that LCD screens invariably, according to the prior art, have flat surfaces which act in effect as a plane mirror, allowing virtual images to be formed.

In some prior art, for example WO 03/016989, non-plane surfaces have been used in an attempt to reduce the effect of a large plane mirror, but these only relate to screens which exhibit medium or higher degrees of pixel integration. In particular WO 03/016989 describes a curved front face feature that exhibits curvature in one dimension only (in the manner of a cylindrical lens) and furthermore is restricted to being applied to rows of pixels within an integrated module. In the case of the present invention, however, there is the facility to apply any arbitrary three-dimensional surface to the cell in order to break up the plane surface presented to the viewer and therefore to substantially break up any images so produced. There is even the facility to apply a different shape to each and every pixel or cell within a display; certainly to have a plurality of these shapes present, probably in a random manner, over the entire array of pixels rather than a single shape that is replicated, as is the case with the prior art.

Diffuse, as opposed to flat, plane or specular, surfaces reflect light falling on the surface from a particular angle in a random direction that is not according to the laws of reflection; this is what prevents virtual images being observed in such diffuse reflectors. In the case where a different shape is provided for each pixel, and where there is a degree of randomness in this shape or the distribution of such shapes, then light falling, from a particular angle, on the display as a whole will be reflected in random directions across the display. The effect, therefore, when viewed at a scale corresponding to the whole display, not just individual pixels, is to provide a diffuse reflecting surface and not a specular one. In practice, the effect of randomness can be achieved by randomly distributing simple shapes across the pixel array. For example said shapes can be simple convex or concave surfaces, such as would be simple to injection mould. These surfaces can exhibit symmetry, for example a particular radius of curvature, provided the symmetry providing parameter is varied randomly across the entire array of pixels—in other words the diffuse effect is retained provided a requisite degree of randomness is also retained.

Advantageously, therefore, each cell further incorporates a transparent element placed in front of the modulating element, said transparent element including a front surface having an arbitrary three dimensional shape that thus serves to reduce the effect of being able to observe images due to specular reflections across the whole screen.

Alternatively, each cell further incorporates a transparent element placed in front of the modulating element, said transparent element including a simple front surface (that serves to reduce the effect of being able to observe images due to specular reflections), the surface being selected from a finite set of such surfaces, but wherein the selection of said surface for each pixel is varied preferably randomly over the entire array.

The means, so far described, by which the effects of light reflected from the first display surface can be reduced employ novel methods, however these can themselves be used in conjunction with prior art means such as anti-reflection coatings—typically these are formed of thin film optical coatings although holographic ‘moth-eye’ means are also known. In some cases it maybe be preferable to use the prior art means in lieu of the novel means disclosed here.

Although the detailed embodiments described above relate primarily to a reflective architecture, the same principles of low or zero integration can be applied in a transmissive architecture. Thus, in one embodiment each cell acts as a variably transmissive pixel and is bonded onto a pane of glass. Here the effect is not necessarily that of a display, and more of a ‘variable window’, that is a window for which the amount of light passing through can be varied according to a demand of some sort. Again windows with a similar function are known in the art, but are based on a scattering liquid crystal effect; this has the effect that the optical states of such windows vary between clear and scattering, with the appearance of the latter being ‘milky’ or similar to smoked glass. The effect, in the scattering state, is mainly one of privacy, that is whilst light is transmitted through the glass, one cannot actually see through it. Also such windows are limited in size by manufacturing issues, and coverage of very large areas is limited by the cost of each individual pane.

In contrast here, this embodiment of the invention may switch gradually from clear to dark—the effect is the same as photo-chromic sunglasses and has some of the same utility. Furthermore, the area over which this variable effect can be achieved is not limited by practical means and the cost is also lower, enabling very large areas to be covered in such a way; in addition the pixellated nature of this system allows a much greater degree of flexibility in its use and operation—although a global shutter mode would be possible, that is all pixels switch the same degree at the same time, it is possible to switch each pixel independently. This latter facility could be used merely to display patterns, or possibly an image, but other more advanced techniques become available. For example, if the requirement is to control the amount of daylight entering a building and if a suitable light sensing means is incorporated into the cell or pixel, the transmission of each pixel can be matched to the light incident on each pixel. Furthermore, if a microprocessor is included in each pixel (or cell), as described above, then each pixel (or cell) can autonomously operate so as to control the actual amount of light transmitted through the pixel and not just the proportion of ambient light transmitted (that is the transmissivity). The manner in which the microprocessor can control the transmissivity of each pixel means is equivalent to the means by which the reflectivity of pixels of the first embodiment is achieved.

In contrast to previous reflective embodiments, the preferred mounting system for the transmissive embodiment of the invention is not a cabled base system. In this case, cells or single pixels are preferably bonded onto panes of architectural glass of an otherwise standard size and quality. These panes can then be handled more or less in the usual manner, thus allowing variable windows of an almost arbitrary size to be built.

Preferably the degree of transmission (transmissivity) of each cell is individually controllable and each cell is bonded onto a pane of glass.

Advantageously, the transmissivity of each pixel can be individually controlled in a manner that allows the absolute amount of light transmitted through each pixel to be controlled rather than the proportional amount.

Unlike reflective embodiments, wherein the electrical components can be placed behind the light modulating element, in the transmissive embodiment the electrical elements may need to be placed to one side, in addition both electrical components and LCDs will generally need to be further mounted onto a larger substrate, typically a pane of glass. This use of a larger substrate can also be utilised in reflective embodiments.

In the case where this large substrate mounts both electronics (on a separate PCB) and LCDs, connecting from PCB to LCD can typically require the use of flexible heat seal connectors. However it is possible to mount the electrical components, including the processor if included, onto a flexible substrate such as Mylar, instead of a normal PCB, which might mean that a flexible connector in addition to a PCB is not required. The problem with this approach is that, if flexible substrate and LCD are both mounted onto the same large substrate, then there will be a height difference between the part of the LCD onto which the connection is to be made—the heat seal ledge—and the contact points of the flexible PCB. The types of the latter that are able to mount components are typically not flexible enough to achieve this variation in height in the space that is available, in which case it would still be necessary to employ a further flexible connector.

However there is a novel method available that overcomes this problem. In this method the flexible PCB is, in effect, mounted upside down on the substrate. As the height of surface mounted electrical components is typically similar to the thickness of LCD glass, then this has the effect of raising the height of the flexible substrate to that of the heat seal ledge. In this case the connection to the latter can now be made directly without the use of a further, more flexible, connector. In effect the electrical components are acting as a spacer for the flexible PCB to raise it to the level of the heat seal ledge. This method can in fact be used for both transmissive and reflective embodiments.

According to a further aspect there is provided a structurally independent cell forming one or more pixels of a display device in use for displaying an image, the cell including a light modulating element at each pixel of variable optical properties so that an image is formed from light variably reflected from the pixels or variably transmitted through the pixels. A processor may be provided in the cell.

Method aspects are also provided.

For further understanding of the invention, embodiments of it will now be described, purely by way of example, with reference to the following diagrams in which:

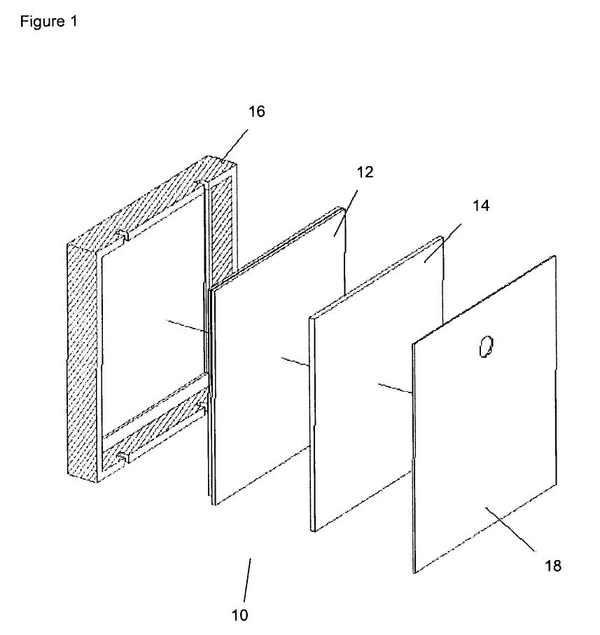

FIG. 1 shows an exploded diagrammatic view of the main components of a cell.

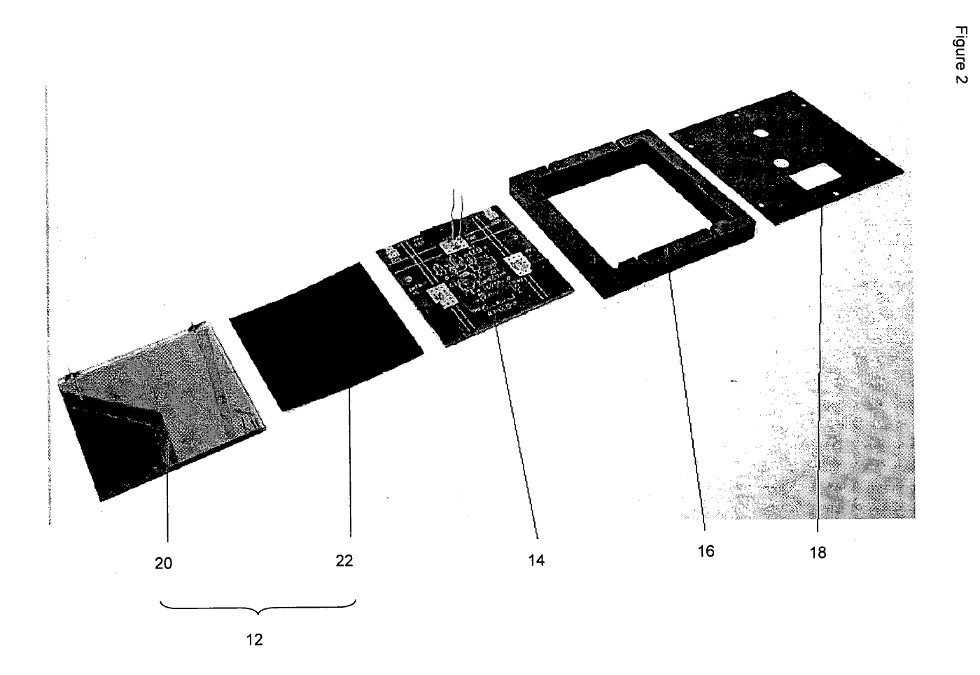

FIG. 2 is a photograph of the major components of a cell, shown disassembled in an exploded view.

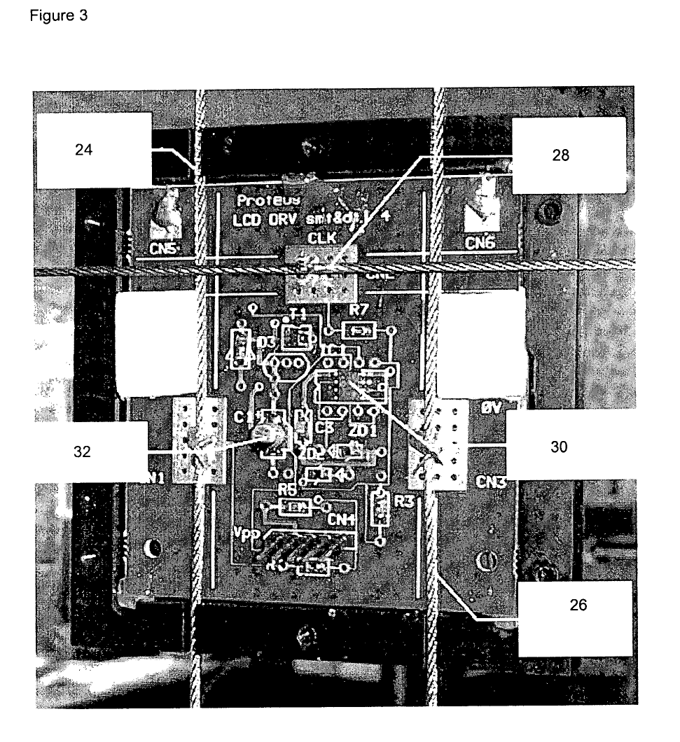

FIG. 3 shows the rear view of a cell (without its rear casing).

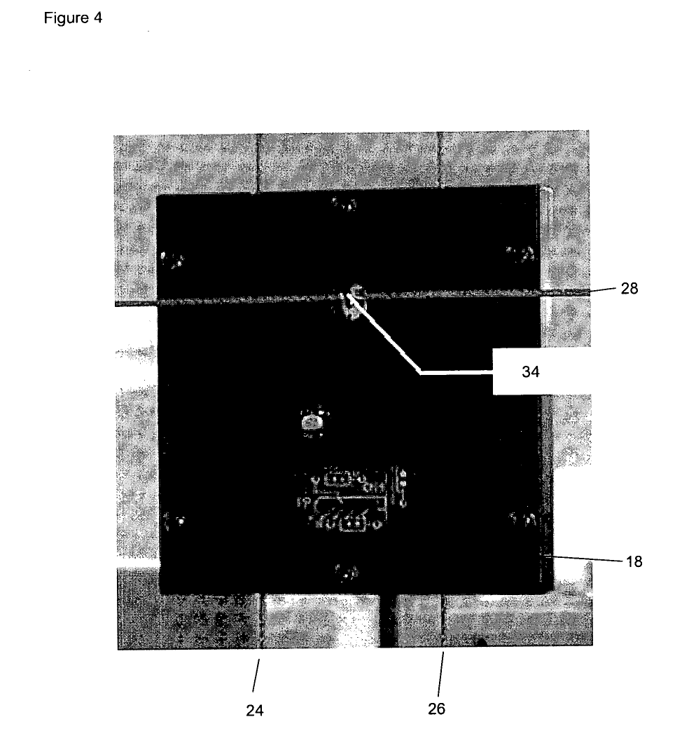

FIG. 4 also shows a cell from the rear.

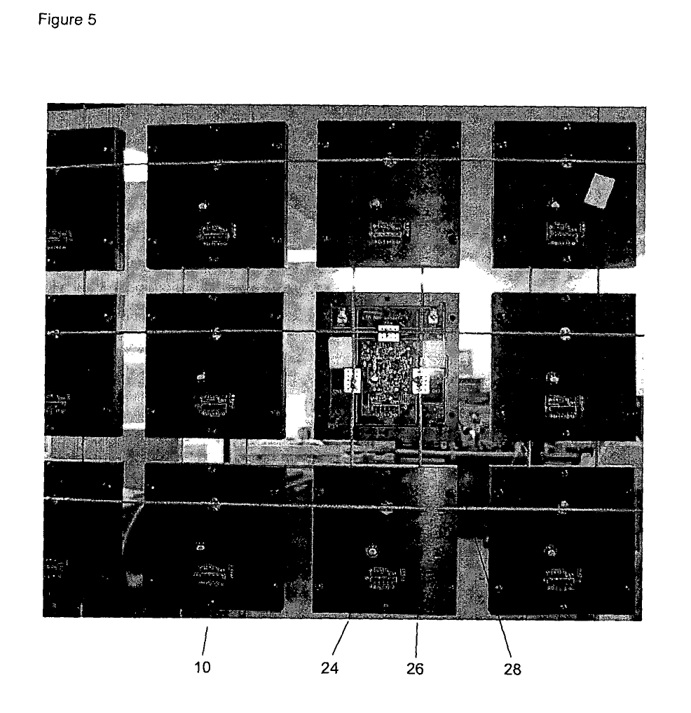

FIG. 5 shows an array of cells from the rear.

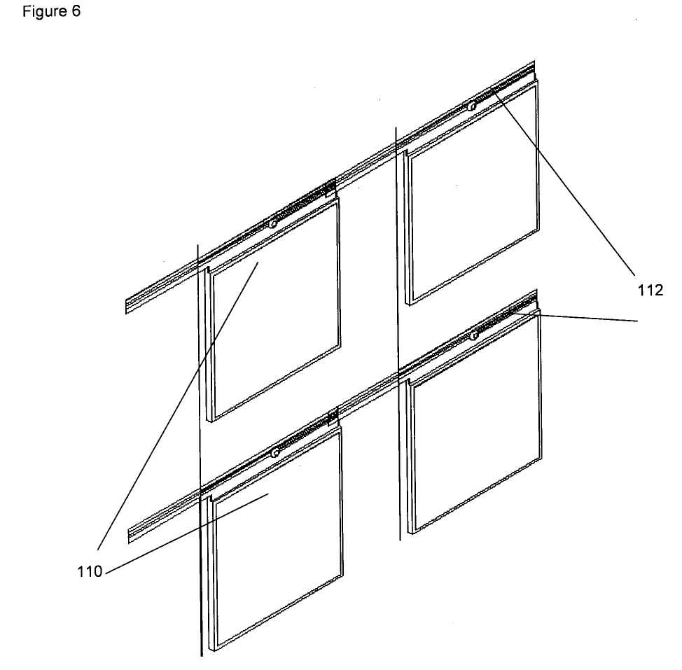

FIG. 6 shows an array of cells according to the 2nd embodiment.

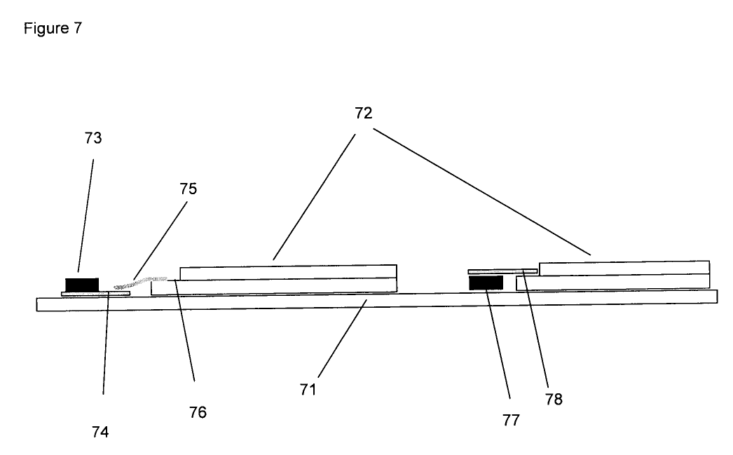

FIG. 7 shows how electrical components can be used as spacers.

With reference to FIG. 1 a cell 10 of a display device consists of a shell 16 with a rear cover 18. Disposed within the shell 16 and rear cover 18 is a light modulating element 12 and a Printed Circuit Board (PCB) 14. The PCB 14 is located between the light modulating element 12 and the rear cover 18.

In the embodiment shown in FIG. 1 the light modulating element 12 is a reflective LCD panel and the viewing direction is from the left. The cables and attachments to the cables are not shown. In alternative embodiments (also not shown), the light modulating element 12 may be a transmissive light modulator. In such embodiments the rear panel 18 would also be transparent, with the PCB preferably mounted to one side of the transmissive modulator not behind it.

With reference to FIG. 2 the light modulating element 12 further comprises a light absorbing backing 22. Furthermore, a reflective means (not shown) is laminated to the rear of an LCD modulator 20. The reflective means is made from a polarising transflective material. In order to fully absorb any light that passes through the reflective means, the light absorbing backing 22 is applied to the rear of the LCD modulator 20.

The PCB 14 is mounted in the shell 16 behind the LCD modulator 20 and the rear cover 18 is attached to the shell 16 by screws. Alternative securing means are possible, for example, a single-piece injection moulded shell, with no separate rear cover. The LCD modulator 20 can be any such device known to those skilled in the art and configured to operate in a reflective mode, in this embodiment it is a standard TN device. The cell 10 is substantially square with sides approximately 8 cm in length. The active light modulating area within each cell is approximately 42.25 cm².

There are three cutaways in the rear cover 18. The first of these is rectangular in shape and allows access to a programming header on the PCB 14. The second is a circular hole, which allows for the height of a capacitor on the PCB 14. The last cutaway permits the externally mounted row cable to be soldered to the PCB 14.

With reference to FIG. 3, a display device further comprises a power cable 24 and an earth return cable 26. The power cable 24 and earth return cable 26 are connected to the PCB 14. Also connected to the PCB is an address cable 28. The power cable 24, earth return cable 26 and address cable 28 are preferably soldered to the PCB 14. Mounted on the PCB 14 are a processor 30, preferably a 12F624 microprocessor device from Microchip, and a capacitor 32. The capacitor 32 stores energy from the power cable 24.

In the embodiment shown in FIG. 3 the power cable 24 also provides data to the PCB 14. Furthermore, the power cable 24 and earth return cable 26 act as vertical support cables and provide structural support for the cell 10.

With reference to FIG. 4, the address cable 28 is connected to the PCB 14 through a cutaway 34 in the rear panel 18. The address cable 28 is preferably soldered to the PCB 14.

With reference to FIG. 5 an array of cells is shown from the rear (with the rear panel 18 removed from one cell for the purpose of demonstration).

With reference to FIG. 6, a second embodiment of the present invention comprises an array of transmissive pixels 110 laminated to a pane of glass (not shown). Clear Mylar PCBs 112 are placed between the pixels 110, the electronic components are mounted onto the PCBs 112. Individual PCBs are connected to each other and to the pixels.

FIG. 7 shows the method whereby electrical components can be used as spacers when light modulating means 72 are mounted onto a substrate 71. In the example on the left hand side of FIG. 7, electrical components 73 are shown mounted on a thin flexible PCB 74. In this case the PCB 74 is not in fact flexible enough to be bonded to a heat seal ledge 76 of the light modulating means 72, so a further, more flexible, connector 75 is needed.

In contrast on the right hand side of FIG. 7, the electrical components 77 and flexible PCB 78 are upside down in comparison to the equivalent items on the left hand side of FIG. 7, and this leaves the flexible PCB 78 substantially level with the heat seal ledge 76 and therefore the latter can be directly bonded to the former without the need for the extra connector.

Note that FIG. 7 shows two pixels mounted onto the same substrate 71, but this is not a necessary aspect of the method, which can be used with a single pixel and a single substrate.

1-53. (canceled)

54. A display device for displaying an image, the display device comprising:
a plurality of structurally independent cells in an array of columns and rows together forming an image to be displayed in use, each cell providing at least one pixel of the image; and,
support means for supporting each cell;
each pixel including a light modulating element of variable optical properties so that an image is formed from light variably reflected from the pixels or variably transmitted through the pixels;
wherein one or more cables connect to each cell, a single cable being arranged to provide the cell with power and data when in use and wherein the support means comprises said single cable and said single cable is load bearing.

55. A display device according to claim 54, wherein each cell provides a single pixel.

56. A display device according to claim 54, wherein a display area of the display device is about 80 m² or 100 m² or greater in size.

57. A display device according to claim 54, wherein each cell has a display area of at least 5 cm² in size.

58. A display device according to claim 54, wherein a cable is continuous across a plurality of cells such that each cell only requires one point of attachment to the cable.

59. A display device according to claim 54, wherein a maximum of three cables connect to each cell, preferably one power and data cable, one address or select cable and one earth return cable.

60. A display device according to claim 54, wherein a cell is attached to a cable via a soldered connection in use.

61. A display device according to claim 54, wherein each cell includes at least one processor, and each cell includes memory.

62. A display device according to claim 61, wherein the processor includes writing means for dynamically overwriting data in non-volatile memory with data that is passed to the cell.

63. A display device according to claim 61, wherein a cell includes at least one sensing means.

64. A display device according to claim 63, wherein the sensing means is arranged to provide the processor with data and the processor is arranged to drive the light modulating element with compensation for the property sensed by the sensing means.

65. A display device according to claim 54, wherein each pixel comprises three sub-pixels and each individual sub-pixel modulates light in only one of the primary or secondary colors.

66. A display device according to claim 54, further comprising display illuminating means and means to synchronize the color of light used to illuminate the display to data transmitted to each pixel such that a full color image is observed.

67. A display device according to claim 63, which further comprises display illuminating means, wherein the sensing means senses the color of light used to illuminate the display such that each cell is able to autonomously display the correct image data according to the sensed color and a full color image is observed.

68. A display device according to claim 54, wherein each cell includes a transparent element placed in front of the light modulating element, the transparent element including a front surface having a three-dimensional shape.

69. A display device according to claim 54, wherein each cell includes a transparent element placed in front of the modulating element, the individual shapes of the front surfaces of the transparent elements varying substantially randomly over an array of the cells.

70. A display device according to claim 54, wherein each cell acts as a variably transmissive window and is preferably bonded onto a transparent substrate.

71. A structurally independent cell forming one or more pixels of a display device in use for displaying an image; the cell including at each pixel a light modulating element of variable optical properties so that an image is formed from light variably reflected from the pixels or variably transmitted through the pixels; the cell further including a processor means.

72. A structurally independent cell according to claim 71, wherein each cell provides a single pixel.

73. A method of operating a display device according to claim 54, including the steps of distributing power, data and address signals to the cells along the support means.
